(19) United States
(12) Patent Application Publication
(10) Pub. No.: US 2022/0270378 A1
(43) Pub. Date: Aug. 25, 2022

(54) LOST ITEM DETECTION SYSTEM, LOST ITEM DETECTION APPARATUS, AND COMPUTER READABLE RECORDING MEDIUM

(71) Applicant: TOYOTA JIDOSHA KABUSHIKI KAISHA, Toyota-shi (JP)

(72) Inventors: Kenji KONDO, Tokyo-to (JP); Toshiki KASHIWAKURA, Tokyo-to (JP); Masanobu TAMURA, Tokyo-to (JP); Takahiro ISHIHARA, Tokyo-to (JP); Tadaaki SAKAMOTO, Tokyo-to (JP)

(73) Assignee: TOYOTA JIDOSHA KABUSHIKI KAISHA, Toyota-shi (JP)

(21) Appl. No.: 17/675,322

(22) Filed: Feb. 18, 2022

(30) Foreign Application Priority Data
Feb. 24, 2021 (JP) 2021-027499

(51) Int. Cl. G06V 20/59

(52) U.S. Cl. CPC G06V 20/59

(57) ABSTRACT

A lost item detection system includes: a vehicle that is capable of driverless and autonomous traveling, the vehicle being configured to travel with a user on board in a preset section; and a center server comprising a first processor configured to acquire a photographic image obtained by capturing an interior of the vehicle from the vehicle, detect a lost item of a user based on the image, specify an owner candidate of the lost item based on the image, acquire information regarding the owner candidate based on a fare settlement history of the owner candidate regarding the vehicle, and register lost item information including the image of the lost item and the information regarding the owner candidate in a lost item ledger in association with each other.

The present application claims priority to and incorporates by reference the entire contents of Japanese Patent Application No. 2021-027499 filed in Japan on Feb. 24, 2021.

### BACKGROUND

The present disclosure relates to a lost item detection system, a lost item detection apparatus, and a computer readable recording medium.

There is a known automated driving system that allows a vehicle to travel by automated driving without requiring a driving operation performed by the driver (refer to JP 2020-158008 A, for example).

### SUMMARY

There have been considerations to apply an automated driving vehicle to be operated as a driverless automated driving bus which is operated with a user on board in a preset section. There has been a demand, in such an automated driving vehicle operated as a driverless vehicle, for a technique capable of detecting a user's lost item in the vehicle.

There is a need for a lost item detection system, a lost item detection apparatus, and a computer readable recording medium that are able to detect a user's lost item in a vehicle operated as a driverless vehicle.

According to one aspect of the present disclosure, there is provided a lost item detection system including: a vehicle that is capable of driverless and autonomous traveling, the vehicle being configured to travel with a user on board in a preset section; and a center server comprising a first processor configured to acquire a photographic image obtained by capturing an interior of the vehicle from the vehicle, detect a lost item of a user based on the image, specify an owner candidate of the lost item based on the image, acquire information regarding the owner candidate based on a fare settlement history of the owner candidate regarding the vehicle, and register lost item information including the image of the lost item and the information regarding the owner candidate in a lost item ledger in association with each other.

### BRIEF DESCRIPTION OF THE DRAWINGS

FIG. 1 is a schematic diagram illustrating an overall configuration of a lost item detection system according to an embodiment;

FIG. 2 is a block diagram illustrating details of individual components of a lost item detection system according to the embodiment; and

FIG. 3 is a flowchart illustrating an example of a lost item detection method executed by a lost item detection system according to the embodiment.

### DETAILED DESCRIPTION

A lost item detection system, a lost item detection apparatus, and a computer readable recording medium storing a lost item detection program according to an embodiment will be described with reference to the drawings. Note that the constituent elements in the following embodiments include those that may be easily replaced by those skilled in the art, or those that are substantially the same.

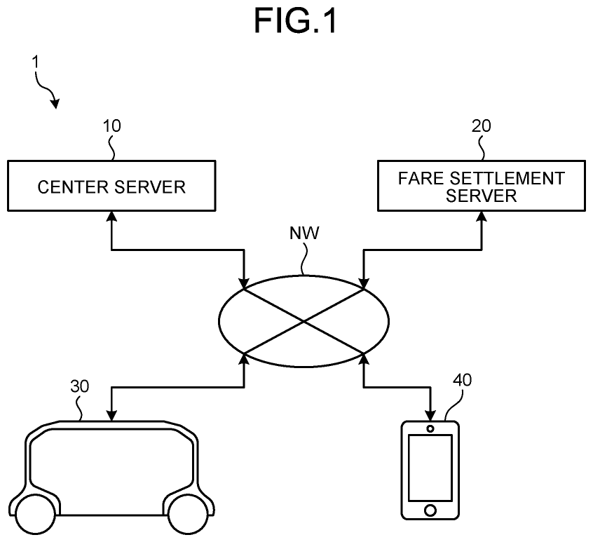

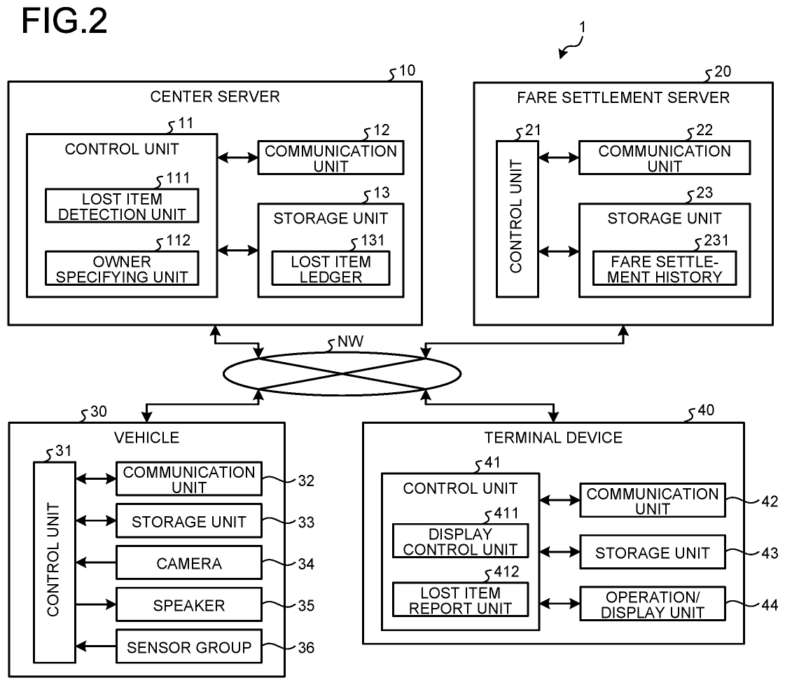

A lost item detection system including a lost item detection apparatus according to the embodiment will be described with reference to FIGS. 1 and 2. As illustrated in FIG. 1, a lost item detection system 1 includes a center server 10, a fare settlement server 20, a vehicle 30, and a plurality of terminal devices 40. The lost item detection apparatus according to the embodiment is implemented by the function of the center server 10 of the lost item detection system 1. The center server 10, the fare settlement server 20, the vehicle 30, and the terminal device 40 all have a communication function so as to be communicable with each other through a network NW. The network NW is constituted with, for example, an Internet network, a mobile phone network, or the like.

The center server 10 is provided for acquiring predetermined information from the vehicle 30 and for detecting a lost item left by a user (passenger) who has boarded the vehicle 30 based on the information. The center server 10 is implemented by a general-purpose computer such as a workstation or a personal computer, for example.

As illustrated in FIG. 2, the center server 10 includes a control unit 11, a communication unit 12, and a storage unit 13. The control unit 11 is specifically equipped with: a processor including a Central Processing Unit (CPU), a Digital Signal Processor (DSP), a Field-Programmable Gate Array (FPGA), or a Graphics Processing Unit (GPU); and a memory device (main storage unit) including Random Access Memory (RAM) and Read Only Memory (ROM).

The control unit 11 loads a program stored in the storage unit 13 into the work area of the main storage unit and executes the program. Through execution of the program, the control unit 11 controls individual components, thereby actualizing a function that matches a predetermined purpose. The control unit 11 functions as a lost item detection unit 111 and an owner specifying unit 112 through execution of a program stored in the storage unit 13.

The lost item detection unit 111 detects a lost item of a user (passenger) in the vehicle 30. First, the lost item detection unit 111 acquires a photographic image of an interior of the vehicle 30 (hereinafter, referred to as “vehicle interior image”) from the vehicle 30 through the network NW. Note that examples of the “vehicle interior image” include a photographic image of the vicinity of the entrance of the vehicle 30, a photographic image of the vicinity of the exit of the vehicle 30, a photographic image of a seat provided in the vehicle 30, and the like. Furthermore, the vehicle interior image may be a still image, a moving image, or a still image clipped from the moving image. The present embodiment will be described on the premise that a still image is used as the vehicle interior image.

For example, the lost item detection unit 111 may acquire the vehicle interior image from the vehicle 30 in each photographing timing of the vehicle interior image by the camera 34 of the vehicle 30, or may acquire the vehicle interior image from the vehicle 30 in preset time intervals.

The lost item detection unit 111 detects a lost item of the user based on the vehicle interior image. The lost item detection unit 111 detects an object and a user individually included in a plurality of temporally consecutive vehicle interior images by using a known image processing technology, for example. Subsequently, the lost item detection unit 111 detects an object captured alone in the vehicle interior image among the detected objects, as a lost item. Note that the “object captured alone in the vehicle interior image” indicates, for example, an object separated from the user by a certain distance or more and for a certain time or more.

The owner specifying unit 112 specifies an owner candidate of the lost item based on the vehicle interior image. Using a known image processing technology, for example, the owner specifying unit 112 specifies a user at a distance less than a certain distance from a lost item in a vehicle interior image captured earlier than the vehicle interior image in which the lost item is detected by the lost item detection unit 111, as an owner candidate of the lost item. The number of the owner candidate(s) of the lost item(s) specified by the owner specifying unit 112 may be one or a plurality of persons.

In addition, in a case where the owner specifying unit 112 detects, based on the vehicle interior image, that one user in the vicinity of the lost item detected by the lost item detection unit 111 has moved away from the lost item and thereafter another user approaches the vicinity (less than a certain distance) of the object, the owner specifying unit 112 may specify this another user as an owner candidate of the lost item. That is, the owner specifying unit 112 may specify all users who have approached the lost item as owner candidates.

In addition, the owner specifying unit 112 may specify a user who possesses (or wears) the lost item detected by the lost item detection unit 111 in a vehicle interior image captured at a time of boarding of a plurality of users on the vehicle 30, as a candidate of the lost item owner. In this manner, with the detection process executed focusing on the belongings of the user at the time of boarding the vehicle, the owner candidate of the lost item may be specified at an early stage with high accuracy.

In addition, the owner specifying unit 112 may specify a user who has been sitting on the seat immediately before the moment in the vehicle interior image of the seat where the lost item has been detected by the lost item detection unit 111 as an owner candidate of the lost item. In this manner, by performing the detection process focusing on the position of the lost item, the owner candidate of the lost item may be specified early and accurately.

When having specified the owner candidate of the lost item, the owner specifying unit 112 registers this information in a lost item ledger 131 of the storage unit 13. First, the owner specifying unit 112 specifies a time at which the owner candidate boarded the vehicle 30 (hereinafter, referred to as “boarding time”) or a time at which the owner candidate alighted the vehicle 30 (hereinafter, referred to as “alighting time”) based on the vehicle interior image acquired from the vehicle 30.

Subsequently, the owner specifying unit 112 acquires a fare settlement history 231 of the owner candidate regarding the vehicle 30 from the fare settlement server 20 based on the boarding time or the alighting time of the owner candidate. Note that “acquiring the fare settlement history 231 of the owner candidate based on the boarding time of the owner candidate” means that, for example, performing, in a case where the owner candidate boards the vehicle 30 that conducts fare settlement at the time of boarding, transmission of information regarding the boarding time of the owner candidate to the fare settlement server 20 and performing a search in the fare settlement history 231 of the owner candidate. Similarly, “acquiring the fare settlement history 231 of the owner candidate based on the alighting time of the owner candidate” means that, for example, performing, in a case where the owner candidate boards the vehicle 30 that conducts fare settlement at the time of alighting, transmission of information regarding the alighting time of the owner candidate to the fare settlement server 20 and performing a search in the fare settlement history 231 of the owner candidate.

Subsequently, the owner specifying unit 112 acquires information regarding an owner candidate based on the fare settlement history 231. Here, the “information regarding an owner candidate” indicates information that may specify an owner candidate, such as a name and a contact address of the owner candidate, and ID of the terminal device 40 possessed by the owner candidate.

Subsequently, the owner specifying unit 112 registers lost item information including the image of the lost item in the lost item ledger 131 of the storage unit 13 in association with information regarding the specified owner candidate. Examples of the “lost item information” include an image of a lost item, a date and time when the lost item was detected as a lost item by the lost item detection unit 111, information regarding the vehicle 30 in which the lost item was found (vehicle number or the like), and information regarding a position in the vehicle in which the lost item was found. In this manner, the owner of the lost item is easily found by registering the lost item information and the information regarding the owner candidate in the lost item ledger 131 in association with each other.

In addition, when the lost item is detected by the lost item detection unit 111, the owner specifying unit 112 may specify the owner candidate only in a case where the lost item meets a predetermined requirement. Note that “the case meeting a predetermined requirement” is, for example, a case where it is not particularly necessary to manage or return an object detected as a lost item, specifically, corresponds to a case where the lost item is an empty may, an empty plastic bottle, a magazine, a newspaper, and the like. In this manner, even in a case where a lost item in the vehicle is detected, it is possible to reduce pointless search for the owner candidate by searching for the owner candidate only when necessary.

In addition, when the owner specifying unit 112 has specified an owner candidate of the lost item and the owner candidate remains in the vehicle 30, the owner specifying unit may perform an in-vehicle announcement in the vehicle 30. In this case, the owner specifying unit 112 first determines whether the owner candidate is still in the vehicle 30 based on the vehicle interior image acquired from the vehicle 30.

That is, the owner specifying unit 112 determines whether the owner candidate is still in the vehicle by using a known image processing technology, for example. When having determined that the owner candidate is still in the vehicle, the owner specifying unit 112 transmits (outputs) in-vehicle announcement information to the vehicle 30 through the network NW. With this process, the in-vehicle announcement information will be reproduced by using a speaker 35 installed in the vehicle 30. Incidentally, the “in-vehicle announcement information” is information for reminding that there is a lost item in the vehicle, and examples of this information are text information including information that may specify the lost item, voice information corresponding to the text information, and the like. In this manner, by making an in-vehicle announcement to the owner candidate in the vehicle, the owner of the lost item may be easily found at an early stage.

In addition, when the owner specifying unit 112 specifies the owner candidate of the lost item, the owner specifying unit may specify the owner by making an inquiry to the owner candidate. In this case, the owner specifying unit 112 acquires the fare settlement history 231 of the owner candidate regarding the vehicle 30 from the fare settlement server 20 based on the boarding time or the alighting time of the owner candidate detected from the vehicle interior image. Subsequently, the owner specifying unit 112 acquires information regarding the owner candidate based on the fare settlement history 231. Subsequently, based on the owner candidate information, the owner specifying unit 112 transmits the lost item information to the terminal device 40 possessed by the owner candidate. Subsequently, when having acquired information indicating that the owner candidate is the owner of the lost item from the terminal device 40 possessed by the owner candidate, the owner specifying unit 112 specifies the user as the owner of the lost item.

Subsequently, the owner specifying unit 112 registers the lost item information including the image of the lost item in the lost item ledger 131 of the storage unit 13 in association with the information regarding the specified owner. In this manner, by making an inquiry to the owner candidate of the lost item, the owner of the lost item may be easily found at an early stage.

Alternatively, when the owner specifying unit 112 specifies the owner candidate of the lost item, the owner specifying unit may specify the owner based on a report from the user. In this case, when having acquired information reporting that the user has left something as a lost item in the vehicle from the terminal device 40 possessed by the user, the owner specifying unit 112 refers to the lost item ledger 131 and searches for the reported lost item candidate. Subsequently, the owner specifying unit 112 transmits, to the reported terminal device 40, an image in which an image of the candidate for the lost item registered in the lost item ledger 131 is partially modified.

Note that examples of the “partially modified image” include an image in which the lost item is partially hidden, an image in which the lost item is partially mosaicked, an image in which the lost item is partially changed in color, an image illustrated only in an outline of the lost item, and an image in which a sticker or a key holder attached to the lost item is hidden. Subsequently, when having acquired, from the terminal device 40, information indicating that the user who possesses the terminal device 40 is the owner of the lost item, the owner specifying unit 112 specifies that the user is the owner of the lost item.

Next, the owner specifying unit 112 registers the lost item information including the image of the lost item in the lost item ledger 131 of the storage unit 13 in association with information regarding the owner. In this manner, by receiving the report of the lost item from the user, it is possible to increase the possibility that the lost item will be returned to the owner.

In addition, when having specified the owner of the lost item based on an inquiry to the user or a report from the user, the owner specifying unit 112 may inquire about the next boarding time of the specified owner. In this case, the owner specifying unit 112 acquires information regarding the next boarding time of the owner from the terminal device 40 possessed by the owner. The acquired information regarding the next boarding time is then registered in the lost item ledger 131 as a pickup time of the lost item. In this manner, by performing inquiry about the next boarding time of the owner when specifying the owner of the lost item and carrying the lost item on the vehicle 30 in operation in accordance with the boarding time, it is possible to return the lost item to the owner.

The communication unit 12 is constituted with, for example, a local area network (LAN) interface board, a wireless communication circuit for wireless communication, or the like. The communication unit 12 is connected to the network NW such as the Internet which is a public communication network. The communication unit 12 communicates with the fare settlement server 20, the vehicle 30, and the terminal device 40 by connecting to the network NW.

The storage unit 13 includes a recording medium such as erasable programmable ROM (EPROM), a hard disk drive (HDD), and a removable medium. Examples of the removable medium include disc recording media such as a universal serial bus (USB) flash drive, a compact disc (CD), a digital versatile disc (DVD), and a Blu-ray (BD; registered trademark). The storage unit 13 may store an operating system (OS), various programs, various tables, various databases, or the like.

The storage unit 13 stores the lost item ledger 131. The lost item ledger 131 is a database that has registered lost item information, information regarding an owner candidate of the lost item, and information regarding the owner of the lost item. Examples of the “lost item information” registered in the lost item ledger 131 include an image of a lost item, a date and time when the item was detected as a lost item by the lost item detection unit 111, information regarding the vehicle 30 in which the lost item was found (vehicle number or the like), and information regarding the position in the vehicle in which the lost item was found. In addition, the lost item information is associated with information regarding the owner candidate or information regarding the owner specified by the owner specifying unit 112.

The fare settlement server 20 is a server for providing a fare settlement service in the vehicle 30. The fare settlement server 20 is implemented by a general-purpose computer such as a workstation or a personal computer, for example.

As illustrated in FIG. 2, the fare settlement server 20 includes a control unit 21, a communication unit 22, and a storage unit 23. The control unit 21, the communication unit 22, and the storage unit 23 are similar in hardware to the control unit 11, the communication unit 12, and the storage unit 13, respectively.

The control unit 21 acquires, from the vehicle 30, fare settlement information of the user, which is information regarding the settlement performed in the vehicle 30, and then stores the fare payment information for each user in the storage unit 23 as the fare settlement history 231. A method of the fare settlement process in the control unit 21 is similar to a method of a general cashless settlement process. For example, when the user makes a fare settlement with a fare settlement terminal device installed in the vehicle 30 using electronic money deposited in advance in the fare settlement application of the terminal device 40, the fare settlement information is transmitted from the vehicle 30 to the fare settlement server 20. In response to this, the control unit 21 performs processing of subtracting the settlement amount from the balance of the electronic money of the user, and transmits the processing result to the vehicle 30 and the terminal device 40. This completes the fare settlement process.

In response to a request from the owner specifying unit 112 of the center server 10, the control unit 21 transmits the fare settlement history 231 stored in the storage unit 23 to the owner specifying unit 112.

The communication unit 22 communicates with the center server 10 and the vehicle 30 by wireless communication via the network NW. The storage unit 23 stores the fare settlement history 231.

The fare settlement history 231 is information related to the user's fare settlement regarding the vehicle 30. The fare settlement history 231 includes information for specifying the user who has made a settlement (for example, ID, name, and the like), date and time of settlement (boarding date and time), place of settlement, amount of settlement, and the like.

The vehicle 30 is a mobile body capable of autonomous traveling (automated traveling). With a capability of driverless and autonomous travel, the vehicle 30 travels with a user in a preset section. As illustrated in FIG. 2, the vehicle 30 includes a control unit 31, a communication unit 32, a storage unit 33, a camera 34, a speaker 35, and a sensor group 36. The control unit 31, the communication unit 32, and the storage unit 33 are similar in hardware to the control unit 11, the communication unit 12, and the storage unit 13, respectively. In addition, a fare settlement terminal device for a user to make a fare settlement is installed near the entrance or the exit of the vehicle 30.

The communication unit 32 communicates with the center server 10 and the fare settlement server 20 by wireless communication via the network NW. The storage unit 33 stores, for example, an image captured by the camera 34, in-vehicle announcement information acquired from the center server 10, and the like as necessary.

The camera 34 is an imaging device incorporating an imaging element such as a charge coupled device (CCD) or a CMOS image sensor (CIS). The cameras 34 are disposed in plurality in the vehicle. The camera 34 is disposed, for example, near the entrance of the vehicle 30, near the exit of the vehicle 30, near seats of the vehicle 30, or the like. The camera 34 transmits the captured vehicle interior image to the center server 10 via the network NW.

The speaker 35 is installed in the vehicle 30. When having acquired the in-vehicle announcement information from the center server 10, the speaker 35 reproduces the in-vehicle announcement information. This reminds a candidate for the lost item in the vehicle of the presence of a lost item in the vehicle.

The sensor group 36 includes sensors for actualizing automated driving, and examples of the sensor include a 3D-LiDAR, a millimeter wave sensor, an infrared sensor, an acceleration sensor, a GPS sensor, and the like.

The terminal device 40 acquires lost item information from the center server 10 or transmits, to the center server 10, a report indicating the owner has left something as a lost item in the vehicle. The terminal device 40 is actualized by, for example, a smartphone, a mobile phone, a tablet terminal device, a wearable computer, or the like owned by the user.

As illustrated in FIG. 2, the terminal device 40 includes a control unit 41, a communication unit 42, a storage unit 43, and an operation/display unit 44. The control unit 41, the communication unit 42, and the storage unit 43 are similar in hardware to the control unit 11, the communication unit 12, and the storage unit 13, respectively. The control unit 41 functions as a display control unit 411 and a lost item report unit 412 through execution of a program stored in the storage unit 43.

The display control unit 411 controls display on the operation/display unit 44. The display control unit 411 controls to display, on the operation/display unit 44, a screen of a fare settlement application installed in the terminal device 40 or a screen of a lost item report application, for example.

The communication unit 42 communicates with the center server 10 by wireless communication via the network NW. The storage unit 43 stores, as necessary, for example, lost item information acquired from the center server 10, a fare settlement application for the settlement of a fare in the vehicle 30, a lost item report application for reporting a lost item in the vehicle 30, and the like.

The operation/display unit 44 is constituted with a touch panel display, for example, and has an input function of receiving an operation by a user's finger or a pen or the like, and a display function of displaying various types of information under the control of the display control unit 411. Under the control of the display control unit 411, the operation/display unit 44 displays a screen of the fare settlement application installed in the terminal device 40, a screen of the lost item report application, and the like.

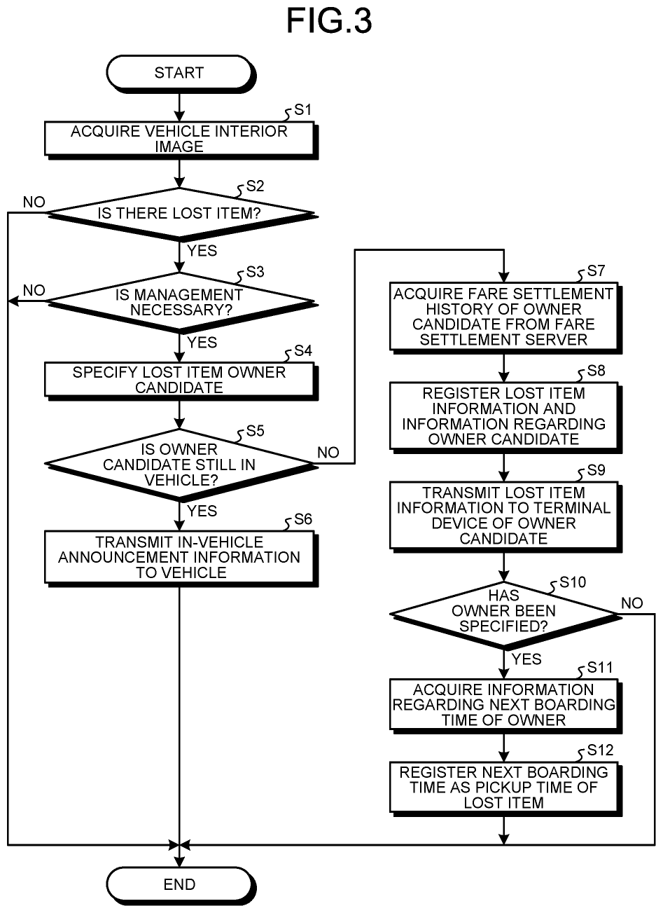

An example of a processing procedure of the lost item detection method executed by the lost item detection system 1 according to the embodiment will be described with reference to FIG. 3. The description with the drawing will be given based on the process executed in the center server 10.

First, the lost item detection unit 111 acquires a vehicle interior image from the vehicle 30 (step S1). Subsequently, the lost item detection unit 111 determines whether there is a lost item in the vehicle based on the vehicle interior image (step S2).

When having determined that there is a lost item in the vehicle (Yes in step S2), the owner specifying unit 112 determines whether it is necessary to manage the lost item (step S3). When having determined in step S2 that there is no lost item in the vehicle (No in step S2), the owner specifying unit 112 ends the present process.

When having determined that it is necessary to manage the lost item (Yes in step S3), the owner specifying unit 112 specifies an owner candidate of the lost item based on the vehicle interior image (step S4). When having determined in step S3 that it is not necessary to manage the lost item (No in step S3), the owner specifying unit 112 ends the present process.

Subsequently, the owner specifying unit 112 determines whether the owner candidate is still in the vehicle based on the vehicle interior image (step S5). When the owner candidate is still in the vehicle (Yes in step S5), the owner specifying unit 112 transmits in-vehicle announcement information to the vehicle 30 (step S6), and ends the present process.

When having determined in step S5 that the owner candidate is not in the vehicle (No in Step S5), the fare settlement history 231 of the owner candidate is acquired from the fare settlement server 20 (step S7). Subsequently, the owner specifying unit 112 registers the lost item information and the information regarding the owner candidate specified from the fare settlement history 231 in the lost item ledger 131 in association with each other (step S8).

The owner specifying unit 112 then transmits the lost item information to the terminal device 40 possessed by the owner candidate (step S9). Subsequently, the owner specifying unit 112 determines whether the owner of the lost item has been specified (step S10). In step S10, the owner specifying unit 112 makes an affirmative determination in a case where information indicating that the owner candidate is the owner of the lost item has been acquired from the terminal device 40 possessed by the owner candidate, and makes a negative determination in a case where the information indicating that the candidate is the owner of the lost item has not been acquired.

When having determined that the owner of the lost item has been specified (Yes in step S10), the owner specifying unit 112 acquires information regarding the next boarding time of the owner from the terminal device 40 possessed by the owner (step S11). When having determined in step S10 that the owner of the lost item has not been specified (No in step S10), the owner specifying unit 112 ends the present process.

Subsequently, the owner specifying unit 112 registers the acquired information regarding the next boarding time in the lost item ledger 131 as the pickup time of the lost item (step S12), and ends the present process.

As described above, according to the lost item detection system, the lost item detection apparatus, and the lost item detection program of the embodiment, it is possible to detect a lost item of the user in the vehicle 30 operated as a driverless vehicle. In addition, by registering information regarding a lost item in the vehicle 30 and its owner candidate in the lost item ledger 131, it is possible to increase the possibility that the lost item will be returned to the owner.

Further effects and modifications may be easily derived by those skilled in the art. Accordingly, broader aspects of the present disclosure are not to be limited to the particular details and representative embodiments illustrated and described above. Accordingly, various alterations and modifications may be made without departing from the spirit or scope of the general inventive concept as defined by the appended claims and their equivalents.

For example, the lost item detection system, the lost item detection apparatus, and the lost item detection program according to the embodiment have a configuration in which the lost item and the owner candidate are detected based on the vehicle interior image captured by the camera 34 of the vehicle 30. However, the lost item and the owner candidate may be detected using other means such as an infrared sensor instead of the camera 34.

Moreover, the lost item detection system, the lost item detection apparatus, and the lost item detection program according to the embodiment have a configuration in which the next boarding time of the owner is inquired when the owner of the lost item has been specified (refer to steps S10 and S11 in FIG. 3). However, the next boarding time may be automatically grasped based on the owner's boarding history (boarding habits) without inquiring the owner. In this case, when having specified the owner of the lost item, the lost item detection unit 111 acquires the fare settlement history 231 of the owner candidate regarding the vehicle 30 from the fare settlement server 20.

Subsequently, the owner specifying unit 112 refers to the fare settlement history 231 and determines whether the date and time of the settlement regarding the owner candidate, that is, the boarding time has periodicity. Note that “having periodicity in the boarding time” includes a case where the user boards the vehicle 30 at the same hour every day, a case where the user boards the vehicle 30 at the same hour on the same day every week, a case where the user boards the vehicle 30 at the same hour on the same day every month, and the like.

When having determined that there is periodicity in the boarding time of the owner candidate, the owner specifying unit 112 predicts the next boarding time of the owner candidate, and registers the predicted boarding time as a pickup time of the lost item in the lost item ledger 131. In this manner, when the owner of the lost item is specified, the next boarding time is predicted based on the boarding history of the owner, and the lost item is carried on the vehicle 30 in operation in accordance with the next boarding time, whereby the lost item may be returned to the owner.

According to the present disclosure, it is possible, in a vehicle operated as a driverless vehicle, to detect a user's lost item in the vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lost item detection system comprising:
a vehicle that is capable of driverless and autonomous traveling, the vehicle being configured to travel with a user on board in a preset section; and
a center server comprising a first processor configured to
acquire a photographic image obtained by capturing an interior of the vehicle from the vehicle,
detect a lost item of a user based on the image,
specify an owner candidate of the lost item based on the image,
acquire information regarding the owner candidate based on a fare settlement history of the owner candidate regarding the vehicle, and
register lost item information including the image of the lost item and the information regarding the owner candidate in a lost item ledger in association with each other.

2. The lost item detection system according to claim 1, wherein in a case where the lost item is detected, the first processor is configured to specify the owner candidate only when the detected lost item meets a predetermined requirement.

3. The lost item detection system according to claim 1, wherein the first processor is configured to:
determine whether the owner candidate is in the vehicle based on the image in a case where the owner candidate is specified; and
in a case where the owner candidate is determined to be in the vehicle, output, to the vehicle, in-vehicle announcement information to remind that there is a lost item in the vehicle, and reproduce the in-vehicle announcement information by using a speaker installed in the vehicle.

4. The lost item detection system according to claim 1, wherein the first processor is configured to:
specify an owner of the lost item by outputting the lost item information to a terminal device possessed by the owner candidate based on the information regarding the owner candidate in a case where the owner candidate is specified; and
in a case where the owner is specified, acquire information regarding a next boarding time of the owner from a terminal device possessed by the owner, and register the acquired information regarding the next boarding time in the lost item ledger as a pickup time of the lost item.

5. The lost item detection system according to claim 1, wherein the first processor is configured to:
output an image in which the image of the lost item registered in the lost item ledger is partially modified to the terminal device in a case where information reporting that the user has left something as a lost item in the vehicle is acquired from a terminal device possessed by a user;
specify that the user is the owner of the lost item in a case where information indicating that the user is the owner of the lost item is acquired from the terminal device;
acquire, from the terminal device, information regarding a next boarding time of the user; and
register the acquired information regarding the next boarding time in the lost item ledger as a pickup time of the lost item.

6. A lost item detection apparatus comprising:
a processor configured to:
acquire, from a vehicle that is capable of driverless and autonomous traveling and that travels with a user on board in a preset section, a photographic image obtained by capturing an interior of the vehicle from the vehicle,
detect a lost item of a user based on the image;
specify an owner candidate of the lost item based on the image;
acquire information regarding the owner candidate based on a fare settlement history of the owner candidate regarding the vehicle; and
register lost item information including the image of the lost item and the information regarding the owner candidate in a lost item ledger in association with each other.

7. The lost item detection apparatus according to claim 6, wherein, in a case the lost item is detected, the processor is configured to specify the owner candidate only when the detected lost item meets a predetermined requirement.

8. The lost item detection apparatus according to claim 6, wherein the processor is configured to:
determine whether the owner candidate is in the vehicle based on the image in a case where the owner candidate is specified; and
in a case where the owner candidate is determined to be in the vehicle, output, to the vehicle, in-vehicle announcement information to remind that there is a lost item in the vehicle, and reproduce the in-vehicle announcement information by using a speaker installed in the vehicle.

9. The lost item detection apparatus according to claim 6, wherein the processor is configured to:
specify an owner of the lost item by outputting the lost item information to a terminal device possessed by the owner candidate based on the information regarding the owner candidate in a case where the owner candidate is specified; and
in a case where the owner is specified, acquire information regarding a next boarding time of the owner from a terminal device possessed by the owner, and register the acquired information regarding the next boarding time in the lost item ledger as a pickup time of the lost item.

10. The lost item detection apparatus according to claim 6, wherein the processor is configured to:
output an image in which the image of the lost item registered in the lost item ledger is partially modified to the terminal device in a case where information reporting that the user has left something as a lost item in the vehicle is acquired from a terminal device possessed by a user;
specify that the user is the owner of the lost item in a case where information indicating that the user is the owner of the lost item is acquired from the terminal device;
acquire, from the terminal device, information regarding a next boarding time of the user; and
register the acquired information regarding the next boarding time in the lost item ledger as a pickup time of the lost item.

11. A non-transitory computer-readable recording medium on which an executable program is recorded, the program causing a processor of a computer to execute:
acquiring, from a vehicle that is capable of driverless and autonomous traveling and that travels with a user on board in a preset section, a photographic image obtained by capturing an interior of the vehicle from the vehicle;
detecting a lost item of a user based on the image;
specifying an owner candidate of the lost item based on the image;
acquiring information regarding the owner candidate based on a fare settlement history of the owner candidate regarding the vehicle; and
registering lost item information including the image of the lost item and the information regarding the owner candidate in a lost item ledger in association with each other.

12. The non-transitory computer-readable recording medium according to claim 11, wherein the program causes the processor to execute:
specifying, in a case the lost item is detected, the owner candidate only when the detected lost item meets a predetermined requirement.

13. The non-transitory computer-readable recording medium according to claim 11, wherein the program causes the processor to execute:
determining whether the owner candidate is in the vehicle based on the image in a case where the owner candidate is specified; and
in a case where the owner candidate is determined to be in the vehicle, outputting, to the vehicle, in-vehicle announcement information to remind that there is a lost item in the vehicle, and reproducing the in-vehicle announcement information by using a speaker installed in the vehicle.

14. The non-transitory computer-readable recording medium according to claim 11, wherein the program causes the processor to execute:
specifying an owner of the lost item by outputting the lost item information to a terminal device possessed by the owner candidate based on the information regarding the owner candidate in a case where the owner candidate is specified; and
in a case where the owner is specified, acquiring information regarding a next boarding time of the owner from a terminal device possessed by the owner, and registering the acquired information regarding the next boarding time in the lost item ledger as a pickup time of the lost item.

15. The non-transitory computer-readable recording medium according to claim 11, wherein the program causes the processor to execute:
outputting an image in which the image of the lost item registered in the lost item ledger is partially modified to the terminal device in a case where information reporting that the user has left something as a lost item in the vehicle is acquired from a terminal device possessed by a user;
specifying that the user is the owner of the lost item in a case where information indicating that the user is the owner of the lost item is acquired from the terminal device;
acquiring, from the terminal device, information regarding a next boarding time of the user; and
registering the acquired information regarding the next boarding time in the lost item ledger as a pickup time of the lost item.
